(19) United States
(12) Patent Application Publication
(10) Pub. No.: US 2021/0010905 A1
(43) Pub. Date: Jan. 14, 2021

(54) TIRE TESTING MACHINE

(71) Applicant: KABUSHIKI KAISHA KOBE SEIKO SHO (KOBE STEEL, LTD.), Hyogo (JP)

(72) Inventors: Takashi SUMITANI, Takasago-shi, Hyogo (JP); Yu SUMIMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 16/979,449

(22) PCT Filed: Feb. 20, 2019
(86) PCT No.: PCT/JP2019/006277

§ 371 Date: Sep. 9, 2020

(30) Foreign Application Priority Data
Mar. 26, 2018 (JP) 2018-058342
Feb. 4, 2019 (JP) 2019-017900

(51) Int. Cl. G01M 17/02

(52) U.S. Cl. CPC G01M 17/021

(57) ABSTRACT

Provided is a tire testing machine allowing rim replacement work to be performed easily and safely without requiring a large overall device length. The tire testing machine includes: a rim table allowing a plurality of rims to be placed thereon; a pair of left and right conveyors that convey a tire having been subjected to a tire test and removed from a rim downstream; and a rim replacement mechanism allowing a replacement target rim selected from the rims placed on the rim table to be replaced with another rim. The rim table is rotatable about a vertical axis at a position below the pair of conveyors, and the rims are placed at respective positions arranged in the rotation circumferential direction thereof. The rim replacing mechanism includes a rotational drive mechanism that rotates the rim table to move the replacement target rim to a replacement position.

### TECHNICAL FIELD

The present invention relates to a tire testing machine having a function of replacing rims.

### BACKGROUND ART

Conventionally is known a tire testing machine capable of testing a plurality of tires having different inner diameters or tread surface widths. Specifically, there is known a tire testing machine including a table on which a plurality of rims corresponding to a plurality of tire sizes, respectively, are placed, a spindle on which each of the plurality of rims is removably mounted, and a mounting-removing mechanism for mounting and removing the plurality of rims on and from the spindle, the tire testing machine having a function of semi-automatically or automatically replacing the rims.

However, the tire testing machine has a limited size, not allowing a large number of rims corresponding to the tires of all sizes to be installed on the tire testing machine itself. A typical tire testing machine allows about 4 to 6 rims to be installed thereon. This makes it necessary, for testing tires of various sizes, to perform work of replacing a rim that is being placed on a rim table in a tire testing machine with another rim prepared outside, for example, as described in Patent Document 1.

For example, in a roller conveyor type tire testing machine 100, as shown in FIG. 7, including a plurality of conveying rollers 101 arranged in the conveying direction of the tire, a rim table 102 supporting a plurality of rims 104 at a position therebelow, a door portion 103 located on the side of the rim table 102 (shaded portion in FIG. 7), opening the door portion 103 and laterally pulling out one of the plurality of rims 104 placed on the rim table 102 allows the rim 104 to be replaced with another rim prepared outside.

However, the work of thus laterally pulling out the rim 104, which is generally made of metal to have a large weight, cannot be easily performed. Besides, in the roller conveyor type tire testing machine 100 as shown in FIG. 7, it is often performed to place a plurality of rims 104 so as to align them in the conveying direction of the tire. For example, when the number of the plurality of rims 104 aligned in the conveying direction is 4 (that is, when four rim mounting positions are set), the length of the arrangement area of the plurality of conveying rollers 101 and the rim table 102 in the conveying direction is very large. Thus, setting the rim mounting position of each of the plurality of rims 104 as aligned in the conveying direction requires the roller conveyor type tire testing machine 100 to have a very large overall length in the conveying direction, and this significantly constrains the place for installing the tire testing machine 100 and makes the structure thereof complicated.

As a conceivable replacement work other than the above is detaching a plurality of conveying rollers 101 existing in preset rim replacement positions, pulling up the rim 104 placed on the rim table 102 and placing another rim prepared outside on the rim table 102. However, this work also cannot solve the problem of requirement for a large total length of the tire testing machine 100. In addition, the structure for allowing the conveying roller 101 to be attached to and detached from the rim replacement position is complicated. Moreover, pulling up all of the rims 104 on the rim table 102 requires respective rim replacement positions to be set on both the inlet side and the outlet side.

### CITATION LIST

### Patent Literature

Patent Literature 1: Japanese Patent No. 4505531

### SUMMARY OF INVENTION

It is an object of the present invention to provide a tire testing machine that allows a rim replacement work to be easily and safely performed without requiring a large overall length thereof in a conveying direction of the tire.

Provided is a tire testing machine, comprising: a rim table that allows a plurality of rims to which tires to be tested are attached to be placed on the rim table, each of the plurality of rims including an upper rim and a lower rim; an upper spindle on which the upper rim is mountable; a lower spindle on which the lower rim is mountable; a pair of conveyors arranged on left and right and configured to convey downstream a tire that has been subjected to the tire test and removed from the rim; and a rim replacement mechanism that allows a replacement target rim that is selected from among the plurality of rims placed on the rim table to be replaced with another rim. The rim table is disposed rotatably about a vertical axis at a position above the lower spindle and below the pair of conveyors, having a horizontal rim placement surface that allows the plurality of rims to be placed on the rim placement surface at respective positions arranged in a rotational circumferential direction of the rim table. The rim replacing mechanism includes a rotational drive mechanism that supports the rim table rotatably about a vertical axis and drives the rim table rotationally so as to move the replacement target rim to a replacement position, which is a position where the replacement target rim can be replaced with another rim while passing through the pair of conveyors vertically.

### BRIEF DESCRIPTION OF DRAWINGS

FIG. 1 is a plan view of a tire testing machine according to an embodiment of the present invention.

FIG. 2 is a front view of the tire testing machine.

FIG. 3 is a side view of the tire testing machine from the inlet side.

FIG. 4 is a plan view showing a rim replacement mechanism of the tire testing machine.

FIG. 5 is a front view showing the rim replacement mechanism.

FIG. 6 is a schematic plan view showing main components of the tire testing machine.

FIG. 7 is a schematic front view showing a conventional tire testing machine.

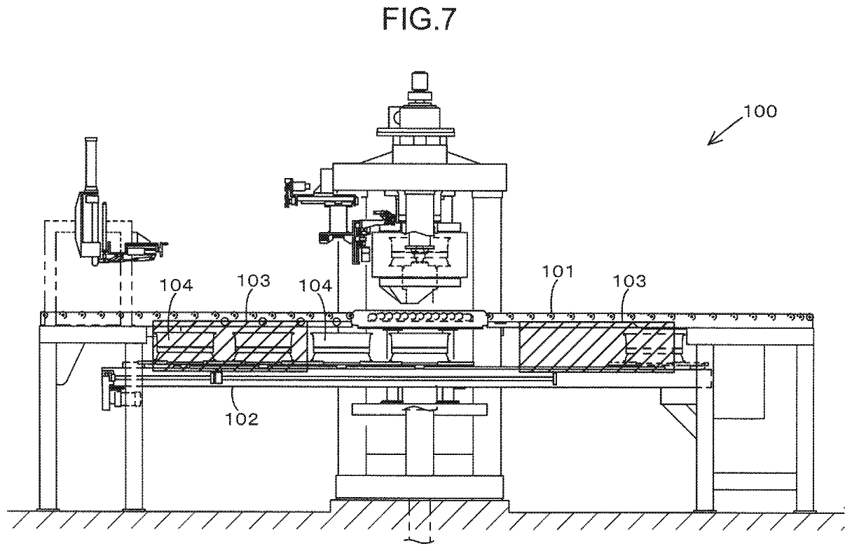

### DESCRIPTION OF EMBODIMENTS

Below will be described embodiments of the present invention with reference to the drawings. The embodiments described below are examples of embodying the present invention, and the present invention is not limited to the examples.

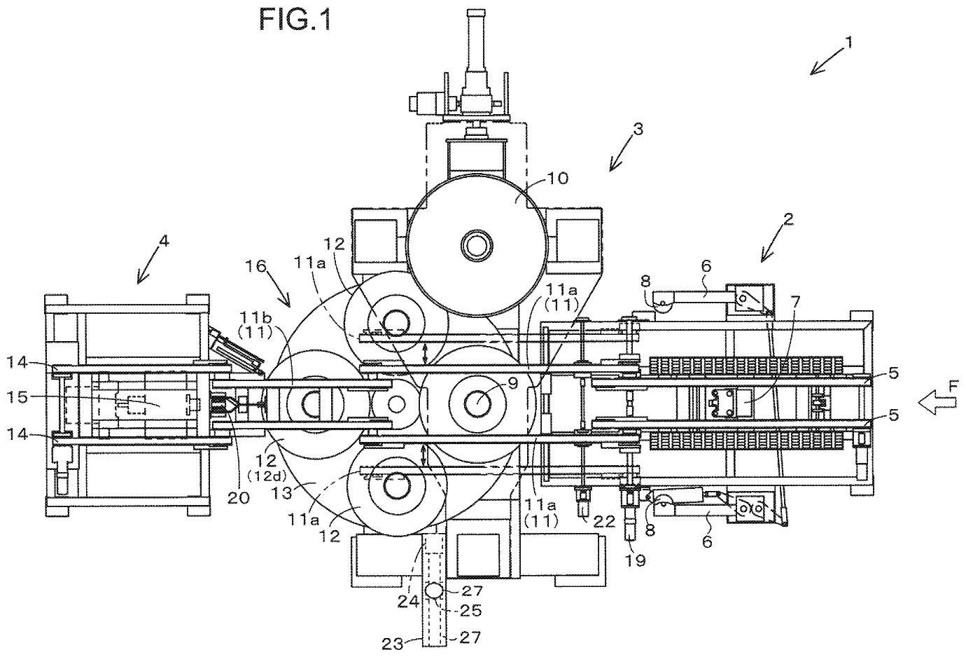

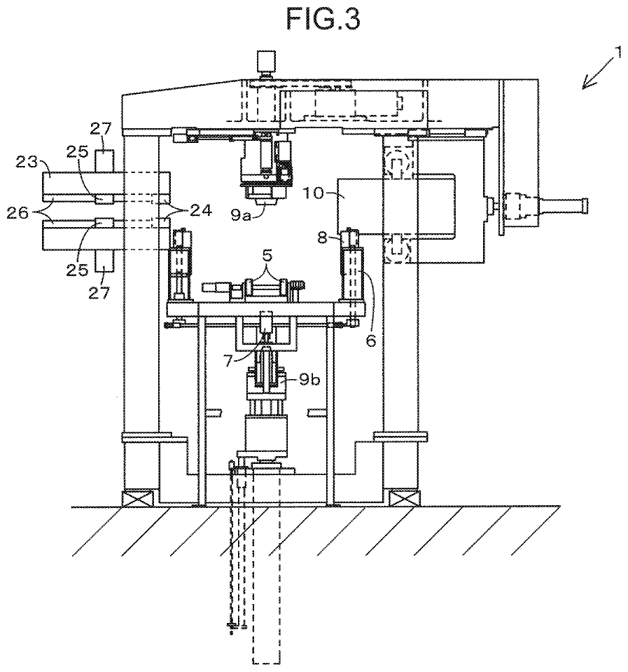

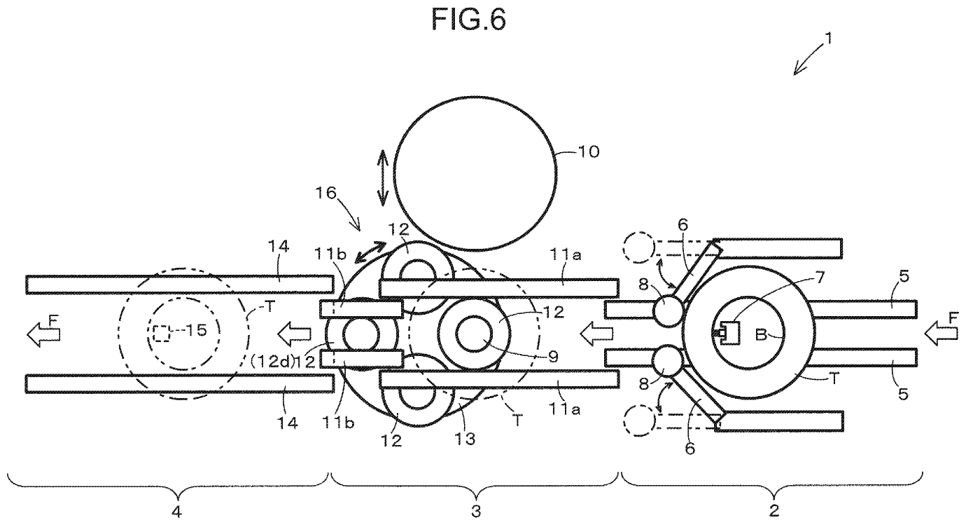

FIGS. 1 to 6 show a tire testing machine 1 according to the embodiment. In the below description about the tire testing machine 1, the length of a conveying path F of a tire T in the conveying direction of the tire T corresponds to the total length of the tire testing machine 1. The horizontal direction that intersects with the conveying path F, more accurately the horizontal direction substantially perpendicular to the conveying path F, corresponds to the depth direction of the tire testing machine 1. The depth direction is also referred to as a left-right direction or width direction of the tire testing machine 1.

The tire testing machine 1 includes a lubrication section 2, a tire testing section 3, and a marking section 4. The lubrication section 2 applies a lubrication liquid to the bead portion B of the tire T while rotating the tire T. The tire testing section 3 performs a tire test while rotating the tire T to which the lubrication liquid has been applied in the lubrication section 2 on a spindle, to detect a singular point that exists in the tire T. The marking section 4 applies marking on the circumferential position where the singular point exists in the tire T. The lubrication section 2, the tire testing section 3, and the marking section 4 are aligned in this order from the upstream side toward the downstream side along the conveying path F.

The lubrication section 2 includes a pair of first conveyors 5 arranged on the left and right and configured to convey the tire T in a posture in which the tire T is lying horizontally, a pair of arm units 6 arranged on the left and right and configured to hold the tire T conveyed in by the pair of first conveyors 5 between the pair of arm units 6, and an application unit 7 configured to apply lubrication liquid to a bead portion B (inner peripheral edge) of the tire T held by the pair of arm units 6.

In this embodiment, each of the pair of first conveyors 5 is a belt conveyor including a conveying belt which is a loop-shaped strip forming an endless track.

Each of the pair of arm units 6 has a distal end, which is provided with a rotary roller 8. The pair of arm units 6 sandwich the conveyed tire T from both the left and right outer sides to bring the rotary rollers 8 into contact with respective tread surfaces which are respective outer peripheral surfaces of the tire T, respectively. The rotary roller 8 rotates so as to allow the tire T to rotate about a vertical axis. The application unit 7, which is formed in a brush shape having a vertical central axis, is raised to a position where the application unit 7 comes into contact with the bead portion B of the tire T held by the pair of arm units 6 to apply the lubrication liquid to the bead portion B. After the application, the application unit 7 is returned to a position below the first conveyor 5 and stored.

The pair of first conveyors 5 convey the tire T on which the lubrication liquid has been applied by the lubrication section 2 to the tire testing section 3 that is a main section.

The tire testing section 3 includes a spindle unit 9, a drum 10, a pair of second conveyor units 11 arranged on the left and right, a rim table 13, and a rim replacement mechanism 16.

The spindle unit 9 holds the tire T so as to allow the tire T to rotate about a vertical axis. The drum 10 has a cylindrical outer peripheral surface having a vertical central axis and is disposed on the side of the spindle unit 9 rotatably about the central axis.

The pair of second conveyor units 11, which correspond to the “pair of conveyors” according to the present invention, convey the tire T conveyed from the lubrication section 2, in a posture in which the tire T lies horizontally. The rim table 13 has a horizontal rim placement surface that allows a plurality of rims 12 to be placed thereon. The rim replacement mechanism 16 operates to allow the replacement target rim 12d that is selected from the rim 12 placed on the rim placement surface to be replaced with another rim.

In this embodiment, each of the pair of second conveyor units 11 is constituted by an upstream conveyor 11a and a downstream conveyor 11b disposed on the downstream side of the upstream conveyor 11a with respect to the conveying direction. Each of the upstream and downstream conveyors 11a and 11b is a belt conveyor including a conveying belt which is a loop-shaped strip forming an endless track. In other words, the pair of second conveyor units 11 are constituted by the pair of the upstream conveyors 11a and the pair of the downstream conveyors 11b.

The tire testing section 3 further includes a not-graphically-shown rotational drive unit that rotationally drives the spindle unit 9.

The spindle unit 9 includes an upper spindle 9a and a lower spindle 9b. The upper spindle 9a and the lower spindle 9b are rod-shaped members rotatable about a common vertical axis. Each of the plurality of rims 12 is constituted by an upper rim 12a to be mounted on a lower end portion of the upper spindle 9a and a lower rim 12b to be mounted on an upper end portion of the lower spindle 9b. The upper rim 12a and the lower rim 12b are disposed so as to be able to vertically sandwich the tire T on the pair of second conveyor units 11.

The drum 10 is disposed so as to allow the outer peripheral surface of the drum 10 to make contact with and separate from the tread surface of the tire T in the radial direction of the tire T, which is held by the spindle unit 9. The test of the tire T is performed by rotating the tire T at a predetermined number of revolutions while keeping the outer peripheral surface of the drum 10 in contact with the tread surface of the tire T. The drum 10 has a rotary shaft, on which a not-graphically-shown load cell for measuring a force and a moment applied from the rotating tire T to the drum 10 is mounted.

Based on the result of measurement by the load cell, tire uniformity and the like are calculated, and the circumferential position and the axial position where the repulsive force of the tire T is the largest are each measured as a “singular point”. The tire test to be performed by the tire testing section 3 includes not only the above-described measurement of the tire uniformity but also a measurement of an outer shape and the like. The tire T whose “singular point” has been measured is rotated by a predetermined angle in the tire testing section 3, and then sent from the tire testing section 3 to the marking section 4.

The marking section 4 includes a pair of third conveyors 14 arranged on the left and right, and a mark stamping device 15. The pair of third conveyors 14 move the tire T in the conveying direction while keeping the tire T in a posture of lying horizontally. The mark stamping device 15 applies marking on a predetermined position on the inner peripheral side of the tire T that is positioned on the pair of third conveyors 14. In this embodiment, each of the pair of third conveyors 14 is a belt conveyor having a conveying belt which is a loop-shaped strip forming an endless track. For example, in the case of performing a tire test on the tire uniformity of the tire T in the tire testing section 3, the mark stamping device 15 applies a mark such as a uniformity mark indicating the “singular point” determined in the tire test on a circumferential position where the singularity of the tire uniformity exists in the tire T. In the case of performing a tire test for measuring the external shape or the like, a mark other than the uniformity mark may be applied to the tire T.

The tire testing section 3 further includes a slide mechanism 22. The slide mechanism 22 is an interval changing mechanism that changes the interval between the pair of the upstream conveyors 11a of the pair of second conveyor units 11 in the left-right direction by moving the pair of upstream conveyors 11a in the direction in which the pair of upstream conveyors 11a come close to and separate from each other along the left-right direction. Specifically, the slide mechanism 22 is capable of sliding the pair of upstream conveyors 11a in the direction. The slide mechanism 22 includes, for example, a ball screw including left and right male screw portions that are reverse to each other and extend in the left-right direction, and a motor that rotates the ball screw, the left and right male screw portions being screwed with respective nuts fixed to the pair of upstream conveyors 11a. The motor rotates the ball screw in the forward and reverse directions to thereby slide the pair of upstream conveyors 11a in a direction in which they come close to and separate from each other. The sliding in the direction in which the pair of upstream conveyors 11a come close to and separate from each other allows, when the size of the tire T to be tested is changed, the rim 12 corresponding to the changed size to be taken out from the rim table 13 located below the second conveyor unit 11.

Specifically, respective slides of the pair of upstream conveyors 11a in the direction in which the pair of upstream conveyors 11a separate from each other, that is, outward in the left-right direction, allows the rim 12 corresponding to the changed size to pass through the space between the pair of upstream conveyors 11a vertically from the rim table 13. Besides, when the rim 12 is lowered, the tire T that is held in the rim 12 and has been subjected to the measurement is received by the pair of upstream conveyors 11a to be left on the upstream conveyors 11a, thereafter allowed to be conveyed to the pair of downstream conveyors 11b. Thus, the tire testing machine 1 allows the interval between the pair of upstream conveyors 11a to be changed depending on the outer peripheral diameter of the rim.

The rim table 13 according to the present embodiment is made of a disk-shaped plate material, and disposed above the lower spindle 9b. The tire testing section 3 further includes a rotational drive mechanism 18, which supports the rim table 13 rotatably about a vertical axis and is able to rotate the rim table 13. In short, the rim table 13 according to the present embodiment is a rotary table.

On the rim placement surface of the rim table 13, the plurality of rims 12 having different sizes from each other can be placed at respective positions arranged in the rotational circumferential direction of the rim table 13. The upper rim 12a and the lower rim 12b constituting each of the plurality of rims 12 are placed on the rim placement surface so as to be vertically stacked, and allowed to be mounted on the upper spindle 9a and the lower spindle 9b, respectively.

The rim table 13 according to the present embodiment, which allows the plurality of rims 12 having different sizes from each other to be placed on the rim placement surface at respective four positions arranged in the rotational circumferential direction, is disposed so as to locate the rotation center axis of the rim table 13 on the carry-out side (outlet side) of the spindle unit 9 with respect to the conveying direction.

The tire testing section 3 has an automatic rim change function. The automatic rim change function allows the tire test of the tire T to be continued even when the tires T of various sizes having different inner circumferential diameters and tread surface widths are carried into the tire testing section 3.

Specifically, the automatic rim change function is a function of automatically replacing the rim 12 mounted on the spindle unit 9 with the rim 12 corresponding to the size of the next tire T carried from the upstream lubrication section 2, based on information about the size of the next tire T and the like, to thereby enable the tire test of the tire T of various sizes to be carried out.

First, when the tire T to be tested is changed, performed is a step of removing the rim 12 currently mounted on the spindle unit 9 from the spindle unit 9. Specifically, in a state in which the next tire T waits before the tire testing section 3, the tire T that has been subjected to the tire test is removed from the spindle unit 9 and conveyed to the marking section 4. Following this conveyance, the driving of the pair of second conveyor units 11 is stopped.

The removal of the rim 12 from the spindle unit 9 is performed by raising the lower spindle 9b to integrate the lower rim 12b mounted on the lower spindle 9b with the upper rim 12a, removing the upper rim 12a from the upper spindle 9a, and lowering the entire rim 12 in which the lower rim 12b and the upper rim 12a are integrated as described above to the rim table 13. Even after the placement of the rim 12 on the rim table 13, the lower spindle 9b is further lowered to thereby cause the rim 12 to be removed from the lower spindle 9b, and reaches a standby position below the rim table 13.

Next is performed a step of mounting the rim 12 corresponding to the changed next tire T on the spindle unit 9. For example, in the case where the next tire T has an inner peripheral diameter larger than the inner peripheral diameter of the preceding tire T, performed is an adjustment of sliding the pair of the upstream conveyors 11a of the pair of the second conveyor units 11 outward in the left-right direction to widen the interval therebetween, based on the information of the tire T.

Besides, based on the information of the tire T, a rim 12 is selected from among the plurality of rims 12 that are stocked in the rim table 13 disposed below the second conveyor unit 11 and correspond to the tires T of various sizes, respectively, the selected rim 12 having an outer peripheral diameter corresponding to the inner circumferential diameter of the next tire T. The thus selected rim 12 can be transferred to a position just above the waiting lower spindle 9b by the rotation of the rim table 13 driven by the rotational drive mechanism 18.

The rise of the waiting lower spindle 9b causes the selected rims 12 to be mounted on the lower spindle 9b. The lower spindle 9b is further raised to thereby cause the upper rim 12a of the rim 12 to be mounted on the upper spindle 9a. Thereafter, the lower spindle 9b is lowered while holding the lower rim 12b to thereby separate the upper rim 12a and the lower rim 12b vertically from each other. Following lowering the lower rim 12b to the standby position below the pair of second conveyor units 11, the next tire T is carried into a position for the tire test. The replacement of the rim 12 is thus automatically carried out.

As described above, the pair of second conveyor units 11 according to the present embodiment make it possible to easily replace the rim 12 mounted on the spindle unit 9 with the rim 12 placed on the rim table 13. Specifically, the tire testing machine 1 according to this embodiment includes a rim replacement device disposed below the second conveyor unit 11 to facilitate the replacement of the rim 12, the rim replacement device including the rim table 13 and the rotational drive mechanism 18.

As described above, the pair of second conveyor units 11 according to this embodiment are constituted by the pair of upstream conveyors 11a located on the inlet side in the conveying path F, and the downstream conveyors 11b located on the outlet side. Each of the pair of upstream conveyors 11a has a length greater than the length of each of the pair of downstream conveyors 11b with respect to the conveying direction. The upper spindle 9a and the lower spindle 9b are disposed above and below the upstream conveyor 11a, respectively. The tire test on the tire T conveyed to the tire testing section 3 is performed, therefore, on the upstream conveyor 11a.

The pair of the downstream conveyors 11b shorter than the pair of upstream conveyors 11a are disposed on respective inner sides of the pair of upstream conveyors 11a in the left-right direction, respectively, and sandwiched by the pair of upstream conveyors 11a from the left and right sides. Specifically, the upstream end portion of the downstream conveyor 11b (the right end portion in FIGS. 1, 2, 4 to 6) and the downstream end portion of the upstream conveyor 11a (the left end portion in FIGS. 1, 2, 4 to 6) overlap each other in the conveying direction, thus being connected to each other normally, that is, during the period in which the tire test is performed.

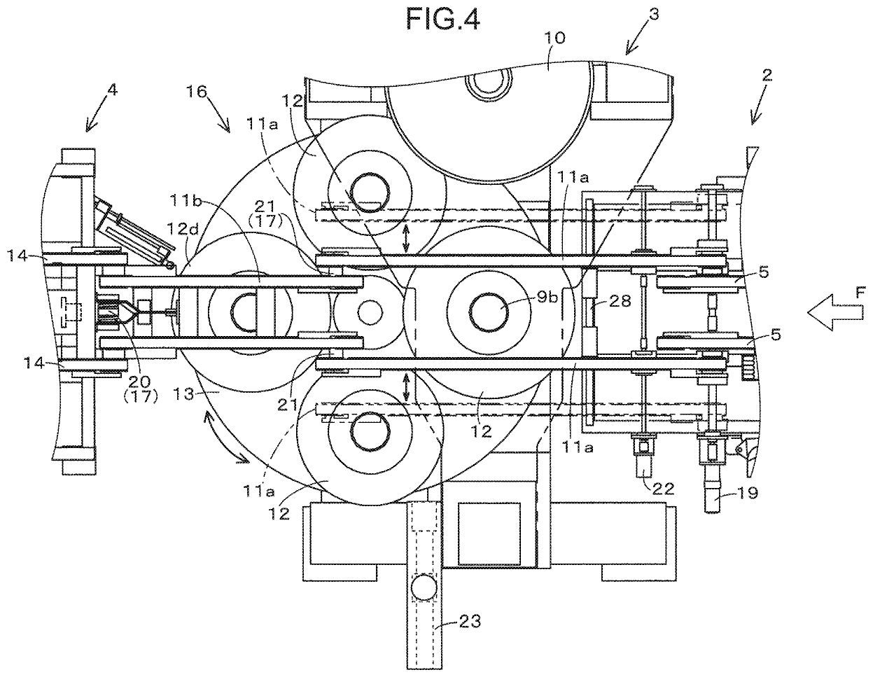

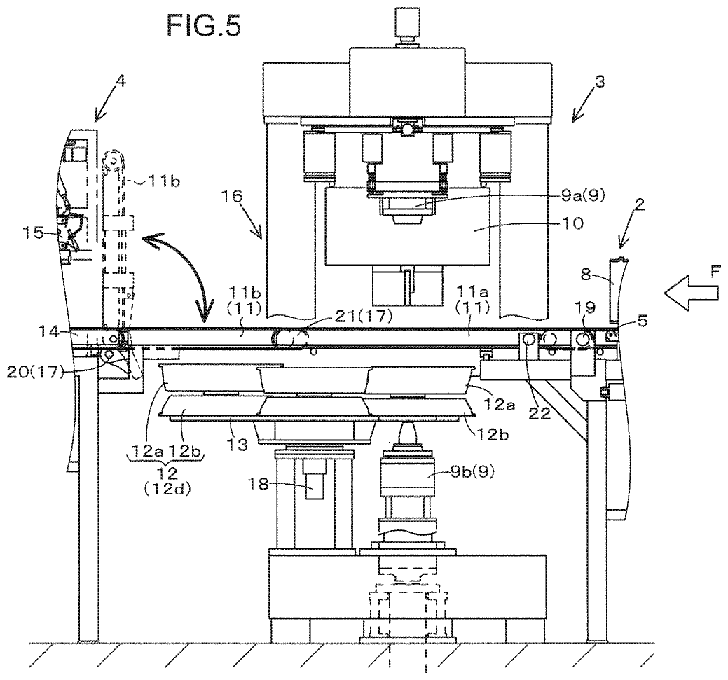

The tire testing machine 1 according to this embodiment further includes a raising and lowering mechanism 17, which constitutes, in cooperation with the rotational drive mechanism 18 and the slide mechanism 22, a rim replacement mechanism 16 for replacing the replacement target rim 12d selected from among the plurality of rims 12 placed on the rim placement surface with another rim. As shown in FIGS. 4 and 5, the raising and lowering mechanism 17 supports, when the tire test is stopped, respective downstream end portions of the pair of downstream conveyors 11b rotatably about the downstream end portions as a fulcrum in a rising direction in which respective upstream end portions of the pair of downstream conveyors 11b are raised so as to be separated upward from the downstream end portions of the pair of upstream conveyors 11a and a falling direction opposite to the rising direction. The raising and lowering mechanism 17 according to this embodiment further has a function of moving the pair of downstream conveyors 11b in the rising and falling directions. The rotational drive mechanism 18 rotates the rim table 13 about the vertical axis as described above to thereby move the replacement target rim 12d of the plurality of rims 12 to the replacement position. The replacement position is a position where the replacement target rim 12d and the other rim can be replaced with each other while they pass through the pair of second conveyor unit 11 vertically. The slide mechanism 22, as described above, changes the interval between the pair of upstream conveyors 11a in a direction intersecting with the conveying direction along the conveying path F when the tire test is stopped. Specifically, the slide mechanism 22 moves the pair of upstream conveyors 11a in a direction in which the pair of upstream conveyors 11a come close to and separate from each other along the left-right direction to thereby change the interval between the pair of upstream conveyors 11a in the left-right direction.

The replacement position according to the present embodiment is a position opened upward through a space formed by raising the downstream conveyors 11b as indicated by a two-dot chain lines in FIG. 5, in other words, a space that had been occupied by the downstream conveyors 11b that has not been raised yet. In short, the replacement position for the rim 12 is set immediately below the space formed by raising the downstream conveyors 11b, on the carry-out side of the tire testing section 3.

Preferably, the raising and lowering mechanism 17 further includes a raising and lowering drive motor 20 and a connection member 21 as means for automatically causing rising and falling motions of the downstream conveyor 11b when the tire test is stopped. The raising and lowering drive motor 20 is connected to the rotational proximal end portion of the downstream conveyor 11b (downstream end portion which is an end portion of the side close to the marking section 4 in this embodiment), and operates to rotationally move the downstream conveyors 11b in the rising and falling direction about the downstream end as a fulcrum, i.e., to raise and lower the upstream end portion of the downstream conveyor 11b. The connection member 21 is switched between a state of interconnecting the downstream end of the upstream conveyor 11a and the upstream end of the downstream conveyor 11b and a state of releasing the interconnection.

The raising and lowering mechanism 17 is not limited to one that automatically raises and lowers the downstream conveyors 11b by the raising and lowering drive motor 20 or the like. The raising and lowering mechanism 17 only has to allow the posture of the downstream conveyors 11b to be switched between a falling posture (i.e., a posture where the upstream end portion of the downstream conveyor 11b is positioned at the same height as the downstream end portion of the upstream conveyor 11a to allow a tire T to be conveyed) and a rising posture (i.e., a posture where the upstream end portion of the downstream conveyor 11b is raised to a position higher than the downstream end portion of the upstream conveyor 11a to form the space allowing the replacement target rim 12d to pass through vertically). In other words, the raising and lowering mechanism 17 only has to support the downstream conveyors 11b so as to allow the downstream conveyors 11b to be raised and lowered between a position corresponding to the falling posture and a position corresponding to the rising posture. Hence, the raising and lowering mechanism according to the present invention does not have to include the raising and lowering drive motor 20 or drive means corresponding thereto. For example, it may be intended to allow an operator to manually shift the downstream conveyors 11b from the falling posture to the rising posture by releasing the interconnection through the connection member 21 between the downstream end of the upstream conveyors 11a and the upstream end of the downstream conveyor 11b.

When the tire test is stopped to replace the rim 12, the rim 12 that had been previously mounted on the spindle unit 9 is removed from the spindle unit 9, and the spindle unit 9 is lowered to the standby position below the rim table 13. The rim 12 removed from the spindle unit 9 is selected as the next replacement target rim 12d. Then, based on information about the placement position of the replacement target rim 12d, the rim table 13 is rotated by the rotational drive mechanism 18, whereby the replacement target rim 12d is transferred to the replacement position.

Upon the automatic rim change operation, the rotational drive mechanism 18 performs also rotational driving of the rim table 13, based on the information of the tire T to be carried in, to move the rim 12 corresponding to the tire T to a position directly above the lower spindle 9b.

The slide mechanism 22 also performs a sliding drive of the pair of upstream conveyors 11a for automatic rim changes. Specifically, for the replacement work of the rim 12, the slide mechanism 22 can further widen the interval between the pair of upstream conveyors 11a in the left-right direction, as shown by the two-dot chain line in FIG. 4, than the interval which is made for the automatic rim change.

The tire testing machine 1 according to this embodiment further includes a support drive mechanism 19 and a guide 28, which support the pair of upstream conveyors 11a in a cantilever form so as to prevent the pair of upstream conveyors 11a from interference with the rim 12 to be replaced. Specifically, the support drive mechanism 19 is disposed at a position on the carry-in side (upstream side) of the tire testing section 3, and supports each of the pair of upstream conveyors 11a at one point during the replacement work, of the rim 12.

Each of the pair of upstream conveyors 11a includes: a driving roller that is located at the upstream end of the upstream conveyor 11a and rotationally driven by the support drive mechanism 19; a driven roller located at the downstream end of the upstream conveyor 11a; and a conveying belt, which is stretched between the driving roller and the driven roller. The support drive mechanism 19 includes a ball spline having a ball spline shaft extending in the left-right direction and an outer cylinder spline-coupled thereto, and a belt drive motor connected to the ball spline shaft to rotationally drive the ball spline shaft. The outer cylinder is fixed to the driving roller. The ball spline shaft is, thus, coupled to the driving roller through the outer cylinder so as to be able to transmit the rotational driving force of the belt drive motor to the driving roller while allowing the driving roller to slide relatively to the ball spline shaft and the belt drive motor in the left-right direction. The belt drive motor applies a rotational force to the driving roller through the ball spline to thereby drive the conveying belt in the conveying direction. The guide 28 is a linear guide, supporting the pair of upstream conveyors 11a so as to allow them to slide in the left-right direction.

The support drive mechanism 19, the guide 28, and the slide mechanism 22, each of which supports the pair of upstream conveyors 11a at a position on the upstream side (inlet side) of the upstream end of the rim table 13 with respect to the conveying direction, does not interfere with the rim 12 on the rim table 13 during the replacement work for the rim 12. Furthermore, the slide mechanism 22 can prevent the pair of upstream conveyors 11a and the rim 12 from interfering with each other, by widening the interval between the pair of upstream conveyors 11a.

Next will be described the action of the rim replacement mechanism 16.

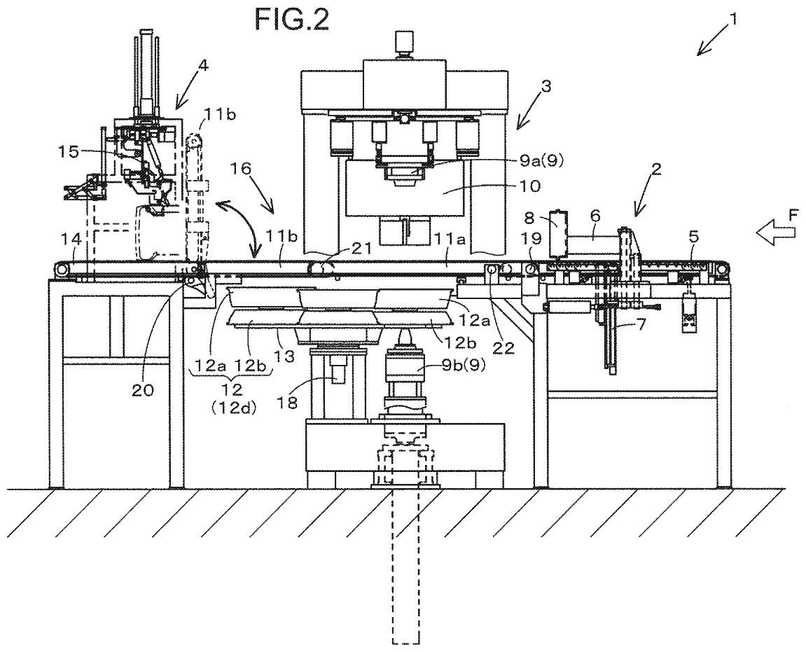

When the tire test is stopped, the rim 12 mounted on the spindle unit 9 is removed from the spindle unit 9, and the lower spindle 9b of the spindle unit 9 waits at a position below the rim table 13. When the safety is recognized thereafter, the interconnection between respective downstream end portions of the pair of upstream conveyors 11a and respective upstream end portions of the pair of downstream conveyors 11b through the connection member 21 of the raising and lowering mechanism 17 is released. This causes the pair of upstream conveyors 11a and the pair of downstream conveyors 11b to be separated from each other. In this state, the raising and lowering drive motor 20 is operated to raise the pair of downstream conveyors 11b to the rising posture indicated by a two-dot chain line in FIGS. 2 and 5 from the previous falling posture. Specifically, the downstream end portions of the downstream conveyors 11b are rotationally moved upward around the proximal end portions, i.e., the upstream end portions, of the pair of downstream conveyors 11b.

On the other hand, the slide mechanism 22 slides each of the pair of upstream conveyors 11a outward in the left-right direction to thereby maximize the interval between the pair of the upstream conveyors 11a within the allowable range as shown by two-dot chain line in FIG. 4.

Thus is secured a sufficient space for the replacement work above the replacement position for the replacement of the replacement target rim 12d. Then, based on information about the mounting position of the rim 12d as the replacement target, the rotational drive mechanism 18 rotates the rim table 13 about the vertical axis to thereby move the rim 12d to the replacement position.

The replacement target rim 12d thus moved to the replacement position can be removed from the rim table 13, by utilization of the space secured above the replacement position, so as to pass through vertically between the pair of second conveyor units 11. Furthermore, onto the position where the replacement target rim 12d had been placed on the rim table 13 previously, another rim prepared outside is placed through the space.

After the completement of the placement work of the other rim, the raising and lowering drive motor 20 of the rim replacement mechanism 16 is operated to return the pair of downstream conveyors 11b from the rising posture to the falling posture. The slide mechanism 22 is then operated to move the pair of upstream conveyors 11a inward in the left-right direction. After the completement of the movement of the pair of upstream conveyors 11a, the connection member 21 is returned to a state of interconnecting the pair of upstream conveyors 11a and the pair of downstream conveyors 11b. Following the completement of such replacement work of the rim 12 by the rim replacement mechanism 16, the next tire test is performed.

The tire testing machine 1 described above is not a conventional slide table system but a rotary table system including a rim table 13 that rotates about the vertical axis to thereby transfer the rim 12. This allows the overall length thereof to be significantly smaller than the total length of the conventional apparatus with respect to the conveying direction. This considerably increases the degree of freedom in the selection of the installation location of the tire testing machine 1.

Besides, the pair of second conveyor units 11 of the tire testing section 3 in the tire testing machine 1 is divided, in the conveying direction, i.e. the direction of the conveying path F, into the pair of upstream conveyors 11a and the pair of downstream conveyors 11b, each of which is a belt conveyor, and the upstream ends of the pair of downstream conveyors 11b is capable of being raised and lowered. This enables the workability of replacing the rim 12 on the rim table 13 to be greatly improved. In other words, the work of replacing the rim 12 can be easily and safely performed. Besides, the configuration of the apparatus can be simplified.

Furthermore, at the time of replacement of the rim 12, widening the interval between the pair of upstream conveyors 11a makes it possible to avoid interference between the pair of upstream conveyors 11a and the replacement target rim 12d taken out upward from the rim table 13.

Furthermore, since the pair of upstream conveyors 11a are supported only at a position upstream of the rim table 13 while being free with no support thereof at the replacement position of the rim 12, there exists no support member that becomes an obstacle at the time of replacement of the rim 12.

It should be noted that the embodiments disclosed herein are to be considered in all respects as illustrative and not restrictive. In particular, in the embodiment disclosed this time, matters that are not explicitly disclosed, such as operating conditions, operating conditions, various parameters, dimensions of components, weights, volumes, and the like, do not depart from the range normally practiced by a person skilled in the art, and values that can be easily assumed by a person skilled in the art are adopted.

As described above, there is provided a tire testing machine that allows a rim replacement work to be easily and safely performed without requiring a large overall length thereof in a tire conveying direction.

Provided is a tire testing machine comprising: a rim table that allows a plurality of rims to which tires to be tested are attached to be placed on the rim table, each of the plurality of rims including an upper rim and a lower rim; an upper spindle on which the upper rim is mountable; a lower spindle on which the lower rim is mountable; a pair of conveyors arranged side by side and configured to convey downstream a tire that has been subjected to the tire test and removed from the rim; and a rim replacement mechanism that allows a replacement target rim that is selected from among the plurality of rims placed on the rim table to be replaced with another rim. The rim table is disposed rotatably about a vertical axis at a position above the lower spindle and below the pair of conveyors, having a horizontal rim placement surface that allows the plurality of rims to be placed on the rim placement surface at respective positions arranged in a rotational circumferential direction of the rim table. The rim replacing mechanism includes a rotational drive mechanism that supports the rim table rotatably about a vertical axis and drives the rim table rotationally so as to move the replacement target rim to a replacement position, which is a position where the replacement target rim can be replaced with another rim while passing through the pair of conveyors vertically. This tire testing machine allows a plurality of rims to be placed on the rim placement surface of the rotatable rim table and the rotation of the rim table enables the replacement target rim selected from the plurality of rims to be moved to the replacement position where the replacement target rim can be replaced with another rim. This makes it possible to perform the rim replacement work easily and safely without requiring a large total length in the conveying direction of the tire.

Preferably, each of the pair of conveyors includes an upstream conveyor and a downstream conveyor disposed downstream of the upstream conveyor in a conveying direction, and the rim replacement mechanism further includes a raising and lowering mechanism that supports the downstream conveyors of the pair of conveyors so as to allow each of the downstream conveyors to be raised and lowered between a falling posture where an upstream end of the downstream conveyor is located at the same height as a downstream end of the upstream conveyor and a rising posture where the upstream end of the downstream conveyor is raised to a higher position than the downstream end of the upstream conveyor to form a space allowing the replacement target rim to pass through vertically. The raising and lowering mechanism allows the downstream conveyor to be raised to form the space, thereby enabling the replacement work of the replacement target rim and another rim to be easily performed through the space.

The rim replacement mechanism, preferably, further includes an interval changing mechanism that changes an interval between the respective upstream conveyors of the pair of conveyors by moving the upstream conveyors in a direction in which the upstream conveyors come close to and separate from each other along the left-right direction. The interval changing mechanism allows, even when each of the replacement target rim and another rim taking the place thereof has a large diameter, the replacement target rim and the other rim taking the place thereof to pass through between the upstream conveyors, by widening the interval between the upstream conveyors according to the diameters.

1. A tire testing machine comprising:
a rim table that allows a plurality of rims to which tires to be tested are attached to be placed on the rim table, each of the plurality of rims including an upper rim and a lower rim;
an upper spindle on which the upper rim is mountable;
a lower spindle on which the lower rim is mountable;
a pair of conveyors arranged on left and right and configured to convey downstream a tire that has been subjected to the tire test and removed from the rim; and
a rim replacement mechanism that allows a replacement target rim that is selected from among the plurality of rims placed on the rim table to be replaced with another rim, wherein
the rim table is disposed rotatably about a vertical axis at a position above the lower spindle and below the pair of conveyors, the rim table having a horizontal rim placement surface that allows the plurality of rims to be placed on the rim placement surface at respective positions arranged in a rotational circumferential direction of the rim table, and
the rim replacing mechanism includes a rotational drive mechanism that supports the rim table rotatably about a vertical axis and drives the rim table rotationally so as to move the replacement target rim to a replacement position, which is a position where the replacement target rim can be replaced with another rim while passing through the pair of conveyors vertically.

2. The tire testing machine according to claim 1, wherein each of the pair of conveyors includes an upstream conveyor and a downstream conveyor disposed downstream of the upstream conveyor in a conveying direction, and the rim replacement mechanism further includes a raising and lowering mechanism that supports the downstream conveyors of the pair of conveyors so as to allow each of the downstream conveyors to be raised and lowered between a falling posture where an upstream end of the downstream conveyor is located at the same height as a downstream end of the upstream conveyor and a rising posture where the upstream end of the downstream conveyor is raised to a higher position than the downstream end of the upstream conveyor to form a space allowing the replacement target rim to pass through vertically.

3. The tire testing machine according to claim 2, wherein the rim replacement mechanism further includes an interval changing mechanism that changes an interval between the respective upstream conveyors of the pair of conveyors by moving the upstream conveyors in a direction in which the upstream conveyors come close to and separate from each other along the left-right direction.
